(19) United States
(12) Patent Application Publication
(10) Pub. No.: US 2022/0108823 A1
(43) Pub. Date: Apr. 7, 2022

(54) INDUCTOR

(71) Applicants: EAGLERISE INTELLIGENT DEVICE CORPORATION LTD., Foshan, Guangdong (CN); FOSHAN EAGLERISE POWER SCIENCE & TECHNOLOGY (SHUNDE) CO., LTD., Foshan, Guangdong (CN)

(72) Inventors: Kakuryo Sho, Foshan, Guangdong (CN); Juncheng Xiao, Foshan, Guangdong (CN); Yilong Wang, Foshan, Guangdong (CN)

(73) Assignees: EAGLERISE INTELLIGENT DEVICE CORPORATION LTD., Foshan, Guangdong (CN); FOSHAN EAGLERISE POWER SCIENCE & TECHNOLOGY (SHUNDE) CO., LTD., Foshan, Guangdong (CN)

(21) Appl. No.: 17/427,907

(22) PCT Filed: Feb. 15, 2019
(86) PCT No.: PCT/CN2019/075148

§ 371 Date: Aug. 2, 2021

(51) Int. Cl. H01F 17/04; H01F 27/29; H01F 3/14

(52) U.S. Cl. CPC H01F 17/045; H01F 2017/048; H01F 3/14; H01F 27/29

(57) ABSTRACT

An inductor includes a first magnetic core column (30) and a second magnetic core column (40), which are same, and a first magnetic core lobe (10) and a second magnetic core lobe (20), which are same. Due to optimized design of structure of magnetic core of the inductor, specifically, the first magnetic core lobe (10) and the second magnetic core lobe (20) are of crescent structures, and outer sides of which are arc surfaces. Compared with an annular inductor, under conditions of same thickness of conducting wires of conductive coils, same number of winding turns, and same size of outer edge of the inductor, net sectional area of magnetic core wound by conductive coils is significantly increased, thereby improving inductance of the inductor. In addition, since magnetic core of the inductor has a split structure, it is convenient for mass production, thereby reducing the production cost.

### TECHNICAL FIELD

The present invention relates to an electronic device, in particular to an inductor.

### BACKGROUND ART

Inductors are commonly known as coils, the simplest inductor is formed by winding a conducting wire around a hollow core for several turns, and an inductor with a magnetic core is formed by winding a conducting wire around the magnetic core for several turns. The inductors with the same structure have the same basic characteristics, but the turns per coil or the presence or absence of the magnetic core will influence the magnitude of the inductance of the inductor. The greater the turns per coil is, the greater the inductance is, and under the condition of the same turns per coil, the inductance is improved after the magnetic core is added to the coil. A hollow coil has no magnetic core, generally, the smaller the turns per coil is, the smaller the inductance is, and the hollow coil is mainly used in high-frequency circuits such as short-wave radio circuits and frequency modulation radio circuits. The difference between an iron core and the magnetic core is that the working frequency is different, the core with the low working frequency is referred to as the iron core, and the core with the high working frequency is referred to as the magnetic core, for example, the one used in a 50 Hz alternating current commercial power frequency circuit is the iron core. A magnetic bar in a magnetic bar coil of the radio circuit is a magnetic core, and its working frequency is up to thousands of Hz. The magnetic cores can be divided into low frequency magnetic cores and high-frequency magnetic cores according to different working frequencies.

The inductor is a common element in a switching power supply, and the loss is theoretically zero due to the fact that the current and voltage phases of the inductor are different. The inductor is commonly used as an energy storage element, and is also commonly used on an input filtering circuit and an output filtering circuit together with a capacitor to smooth the current. The inductor, also known as a choke coil, is characterized by endowing “large inertia” of the current flowing through it, that is, the current on the inductor must be continuous due to the continuous property of the magnetic flux, otherwise a large voltage spike will be generated. As a magnetic element, the inductor has the problem of magnetic saturation. Some applications allow saturation of the inductor, some applications allow the inductor to enter saturation starting from a certain current value, and some applications do not allow saturation of the inductor. In general, the inductor works in a “linear region”, and at this time, the inductance is a constant and does not change along with the terminal voltage and current. However, the switching power supply has a non-negligible problem that the winding of the inductor will result in two distribution parameters (or parasitic parameters), one is inevitable winding resistance, and the other is distributed stray capacitance related to the winding process and material. The influence of the stray capacitance is low at low frequency, but appears as the frequency increases, and when the frequency is up to a certain value, the inductor may become capacitance characteristic. The inductor is generally composed of a framework, a winding, a shielding cover, a packaging material, a magnetic core or an iron core and the like, wherein the magnetic core is generally made of materials such as nickel-zinc ferrite or manganese-zinc ferrite, and the magnetic core can be of a tank type, an RM type, an E type, an EC type, an ETD type, an EER type, a PQ type, an EP type, an annular type, etc.

As shown in FIG. 1, it is a schematic structural diagram of an inductor with a flat wire wound around an annular magnetic core vertically, the annular magnetic core is the most economical, and compared with other magnetic cores, the annular magnetic core is the lowest in cost, large in output current, small in loss, resistant to voltage, high in inductance and low in price. Due to its good EMC electromagnetic characteristics and the good heat dissipation performance of the vertical winding structure, the annular magnetic core is widely used as a high-power high-frequency inductor, such as a boost inductor of a photovoltaic inverter, a high-frequency inverter filter inductor, a variable-frequency air conditioner PFC inductor, a UPS rectifier inverter inductor, a charging pile PFC inductor, a PFC inductor of a charger of a new energy automobile and the like. In the circuit design of the power supply, the high power density of a high-frequency power inductance element needs to be optimized. Specifically, the inductance of the inductor with the annular magnetic core is improved as much as possible. Due to the improvement of the inductance, the stability control of a power supply device is greatly facilitated, the PFC ripples of the power supply device are reduced, the higher harmonic content of PFC current is improved, and the efficiency of the power supply is improved. In the actual circuit design, the inductor needs to have higher magnetic conductivity, lower loss, higher saturation magnetic flux density, higher use frequency, higher use temperature zone, smaller size and weight and lower installation height. Not only does the spatial size of the inductor need to be defined, but also the thickness of the winding wire of the inductor (i.e. the sectional area of the winding wire is defined) is defined. In the prior art, in order to improve the inductance of the inductor with the annular magnetic core, the annular magnetic core is made of a magnetic material of an iron-nickel alloy soft magnetic powder core. Although the inductor with the annular magnetic core made of such magnetic material easily obtains a large inductance under the conditions of high frequency and large current, and has the characteristics of high efficiency and small volume, the production cost of such inductor is extremely high. In addition, the winding cost of the inductor with the annular magnetic core is high, and accordingly mass production is difficult to achieve.

### SUMMARY OF INVENTION

The main technical problem solved by the present invention is to improve the inductance of an inductor under the condition of limiting the spatial size of the inductor and the thickness of a winding wire of the inductor.

According to a first aspect of the present invention, an inductor is provided, including a first magnetic core column and a second magnetic core column, which are the same, and a first magnetic core lobe and a second magnetic core lobe, which are the same;

each of the first magnetic core lobe and the second magnetic core lobe has two opposite side faces, and a bottom surface and an arc surface connect the two opposite side faces;

conductive coils are wound around both of the first magnetic core column and the second magnetic core column; wherein one end of the conductive coil wound around the first magnetic core column serves as a terminal of the inductor, the other end of the conductive coil wound around the first magnetic core column is connected to one end of the conductive coil wound around the second magnetic core column, and the other end of the conductive coil wound around the first magnetic core column serves as the other terminal of the inductor; and

the first magnetic core lobe and the second magnetic core lobe are arranged in such a manner that the bottom surfaces thereof are opposite to each other, and the first magnetic core column and the second magnetic core column are arranged side by side between the first magnetic core lobe and the second magnetic core lobe, so that the end faces of the first magnetic core column and the second magnetic core column are in contact with the bottom surfaces of the first magnetic core lobe and the second magnetic core lobe respectively.

According to an inductor in the above-mentioned embodiment, due to the optimized design of the structure of the magnetic core of the inductor, the first magnetic core lobe and the second magnetic core lobe of the inductor are of crescent structures, and the outer sides thereof are arc surfaces, so that compared with an annular vertical winding inductor, under the conditions of the same thickness of the conducting wires of the conductive coils, the same number of winding turns, and the same size of the outer edge of the inductor, the net sectional area of the conductive coil wound around the magnetic core is significantly increased so as to improve the inductance of the inductor. In addition, since the magnetic core of the inductor has a split structure, it is convenient for mass production of the inductor, thereby reducing the production cost.

### BRIEF DESCRIPTION OF DRAWINGS

FIG. 1 is a schematic structural diagram of an inductor with a flat wire wound around an annular magnetic core vertically;

FIG. 2 is a schematic structural diagram of a magnetic core of an inductor in one embodiment;

FIG. 3 is a schematic diagram of the arrangement of an air gap of a magnetic core lobe of the inductor in one embodiment;

FIG. 4 is a schematic diagram of the arrangement of an air gap of a magnetic core column of the inductor in one embodiment;

FIG. 5 is a schematic diagram of the comparison between the inductor disclosed in the present application and an annular inductor;

FIG. 6 is a schematic diagram of a three-dimensional structure of the inductor in one embodiment;

FIG. 7 is a schematic diagram of a split structure of the inductor in one embodiment;

FIG. 8 is a schematic diagram of the terminal connection of the inductor in one embodiment;

FIG. 9 is a schematic diagram of the spatial arrangement of an elliptical inductor and an annular inductor in one embodiment.

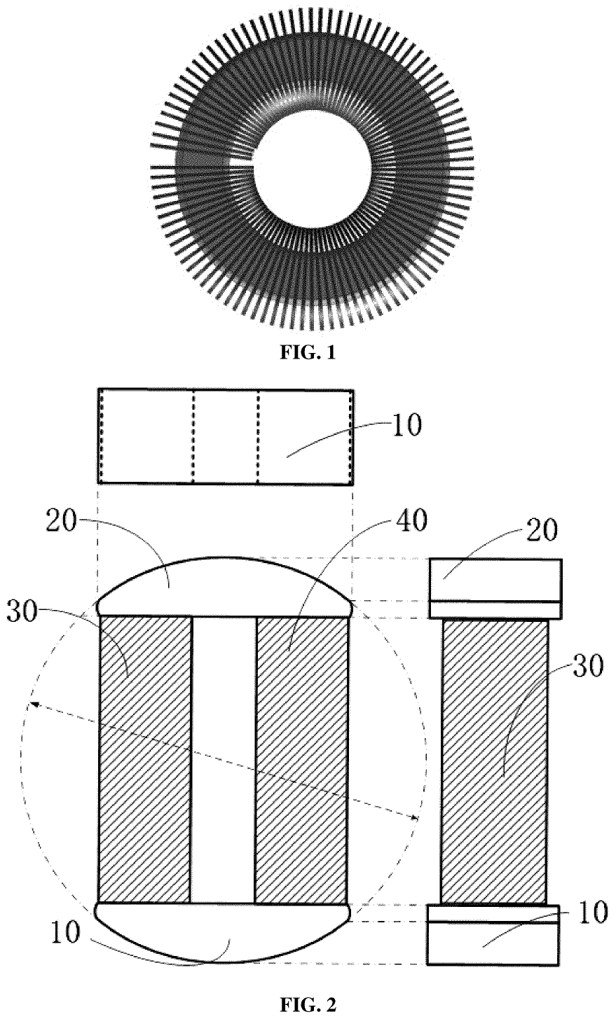

### DETAIL DESCRIPTION

Hereinafter, the present invention will be further described in detail through specific embodiments in conjunction with the drawings. Similar numbers are used for similar elements in different embodiments. In the following embodiments, many detailed descriptions are for better understanding of the present application. However, those skilled in the art should understand that part of the features can be omitted under different circumstances, or can be replaced by other elements, materials and methods. In some cases, some operations related to the present application are not shown or described in the specification, in order to avoid the core part of the present application from being overwhelmed by excessive descriptions. It is not necessary for those skilled in the art to describe these related operations in detail, and they can fully understand the related operations from the description in the specification and the general technical knowledge in the art.

In addition, the characteristics, operations or features described in the specification can be combined in any appropriate manner. At the same time, the steps or actions in the method description can also be sequentially exchanged or adjusted in a manner understood by those skilled in the art. Therefore, the various sequences in the specification and the drawings are only for the purpose of clearly describing some embodiment, and are not meant to be necessary sequences, unless it is otherwise specified that a certain sequence must be followed.

The serial numbers themselves, for example, “first”, “second” and the like herein, are only used for distinguishing the described objects and do not have any sequence or technical meaning. The words “connection” and “link” mentioned in the present application include direct and indirect connections (links) unless otherwise specified.

In the embodiment of the present invention, the structure of a magnetic core of an inductor is optimized. Specifically, the magnetic core of the inductor located at the outside of a coil is designed into a crescent structure to increase the net sectional area of the magnetic core, wound by the conductive coils, of the inductor, thereby increasing the inductance of the inductor.

### Embodiment 1

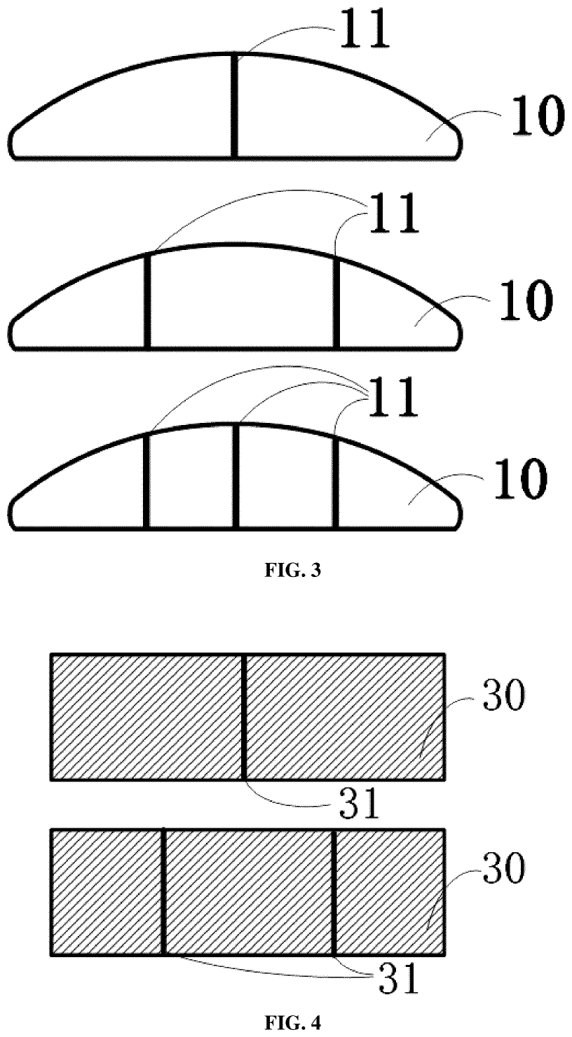

Please refer to FIG. 2, it is a schematic structural diagram of a magnetic core of an inductor in one embodiment. The inductor includes a first magnetic core column 30 and a second magnetic core column 40, which are the same, and a first magnetic core lobe 10 and a second magnetic core lobe 20, which are the same. Each of the first magnetic core lobe 10 and the second magnetic core lobe 20 has two opposite side faces, and a bottom surface and an arc surface connect the two opposite side faces. Conductive coils are wound around both of the first magnetic core column 30 and the second magnetic core column 40. One end of the conductive coil wound around the first magnetic core column 30 serves as a terminal of the inductor, the other end of the conductive coil wound around the first magnetic core column 30 is connected to one end of the conductive coil wound around the second magnetic core column 40, and the other end of the conductive coil wound around the first magnetic core column 30 serves as the other terminal of the inductor. The first magnetic core lobe 10 and the second magnetic core lobe 20 are arranged in such a manner that the bottom surfaces thereof are opposite to each other, and the first magnetic core column 30 and the second magnetic core column 40 are arranged side by side between the first magnetic core lobe 10 and the second magnetic core lobe 20, so that the end faces of the first magnetic core column 30 and the second magnetic core column 40 are in contact with the bottom surfaces of the first magnetic core lobe 10 and the second magnetic core lobe 20 respectively. In one embodiment, the first magnetic core column 30 and the second magnetic core column 40 are cuboids or cylinders. In one embodiment, the edges between the bottom surfaces and the arc surfaces of the first magnetic core lobe 10 and the second magnetic core lobe 20 are rounded. In one embodiment, the edges of the first magnetic core column 30 and the second magnetic core column 40 are rounded. The radius of the round edge is one-tenth to one-fifth of the radius of circumcircle of the first magnetic core column 30 or the second magnetic core column 40. In one embodiment, the end faces of the first magnetic core column 30 and the second magnetic core column 40 are slightly smaller than a half of the bottom surfaces of the first magnetic core lobe 10 and the second magnetic core lobe 20.

As shown in FIG. 3, it is a schematic diagram of the arrangement of air gaps of the magnetic core lobes of the inductor in one embodiment. Air gap(s) 11 can be arranged in the first magnetic core lobe 10 and/or the second magnetic core lobe 20. In one embodiment, one air gap 11 is arranged on the medial surfaces of the first magnetic core lobe 10 and/or the second magnetic core lobe 20. In one embodiment, two air gaps 11 are arranged on the trisection sections of the first magnetic core lobe 10 and/or the second magnetic core lobe 20. In one embodiment, three air gaps 11 are arranged on the quartering sections of the first magnetic core lobe 10 and/or the second magnetic core lobe 20. In addition, the arrangement of the air gaps 11 of the first magnetic core lobe 10 and the second magnetic core lobe 20 can be the same or different. The difference can be that the first magnetic core lobe 10 is provided with the air gap 1 and the second magnetic core lobe 20 is not provided with the air gap 11; or, the respective air gaps 11 of the first magnetic core lobe 10 and the second magnetic core lobe 20 are arranged at different positions, and the numbers of the respective air gaps 11 of the first magnetic core lobe 10 and the second magnetic core lobe 20 are different. In one embodiment, the planes where the air gaps 11 in the first magnetic core lobe 10 and/or the second magnetic core lobe 20 are located are perpendicular to the bottom surfaces of the first magnetic core lobe 10 and/or the second magnetic core lobe 20.

As shown in FIG. 4, it is a schematic diagram of the arrangement of the air gaps of the magnetic core columns of the inductor in one embodiment. The air gaps 31 can be arranged in the first magnetic core column 30 and/or the second magnetic core column 40. In one embodiment, one air gap 31 is arranged on the medial surfaces of the first magnetic core column 30 and/or the second magnetic core column 40. In one embodiment, two air gaps 31 are arranged on the trisection sections of the first magnetic core column 30 and/or the second magnetic core column 40. In one embodiment, the air gaps 31 are arranged on the quartering sections of the first magnetic core column 30 and/or the second magnetic core column 40. In addition, the arrangement of the air gaps 11 of the first magnetic core column 30 and/or the second magnetic core column 40 can be the same or different. The difference can be that the first magnetic core column 30 is provided with the air gap 31 and the second magnetic core column 40 is not provided with the air gap 31; or, the respective air gaps 31 of the first magnetic core column 30 and/or the second magnetic core column 40 are arranged at different positions, and the numbers of the respective air gaps 11 of the first magnetic core 30 and/or the second magnetic core 40 are different.

Further, non-magnetic substances are placed in the air gaps of the magnetic core columns and the magnetic core lobes to adjust the magnetic circuit reluctance required by the inductor disclosed in the present application, so as to obtain the required inductance and meet the requirements of a coupling coefficient between two coils. In addition, multiple parts of the first magnetic core lobe and/or the second magnetic core lobe divided by the air gaps can be made of different materials, and multiple parts of the first magnetic core column and/or the second magnetic core column divided by the air gaps can be made of different materials. That is, different magnetic core blocks cut by the air gaps can be made of the same material or different materials, so as to adjust the magnetic circuit reluctance required by the inductor disclosed in the present application.

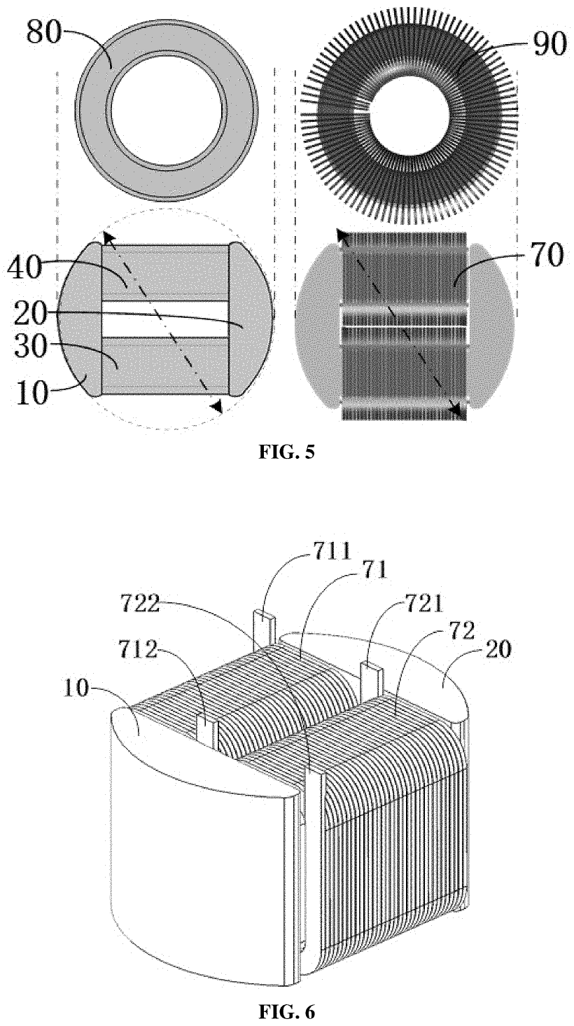

As shown in FIG. 5, it is a schematic diagram of the comparison between the inductor disclosed in the present application and an annular inductor. The magnetic core of the inductor disclosed in the present application includes the first magnetic core column 30 and the second magnetic core column 40, which are the same, and the first magnetic core lobe 10 and the second magnetic core lobe 20, which are the same. The arc surfaces of the first magnetic core lobe 10 and the second magnetic core lobe 20 are axially symmetric. The conductive coils 70 are respectively wound around the first magnetic core column 30 and the second magnetic core column 40. The cross sections of the first magnetic core column 30 and the second magnetic core column 40 around which the conductive coils 70 are wound are greater than the cross section of an annular magnetic core 80. The total volume of the magnetic core of the inductor disclosed in the present application is greater than the volume of the magnetic core of the annular inductor. The external dimension of the inductor disclosed in the present application is the same as that of an annular sensor 90 in the direction of the first magnetic core lobe 10 and the second magnetic core lobe 20, but the dimension in the direction of the first magnetic core column 30 and the second magnetic core column 40 is smaller than that of the annular sensor 90. In one embodiment, the conductive coil 70 is formed by flat wire wound vertically. In one embodiment, the material of the first magnetic core column 30, the second magnetic core column 40, the first magnetic core lobe 10 and the second magnetic core lobe 20 is ferrites such as nickel-zinc ferrite, manganese-zinc ferrite and magnesium-zinc ferrite.

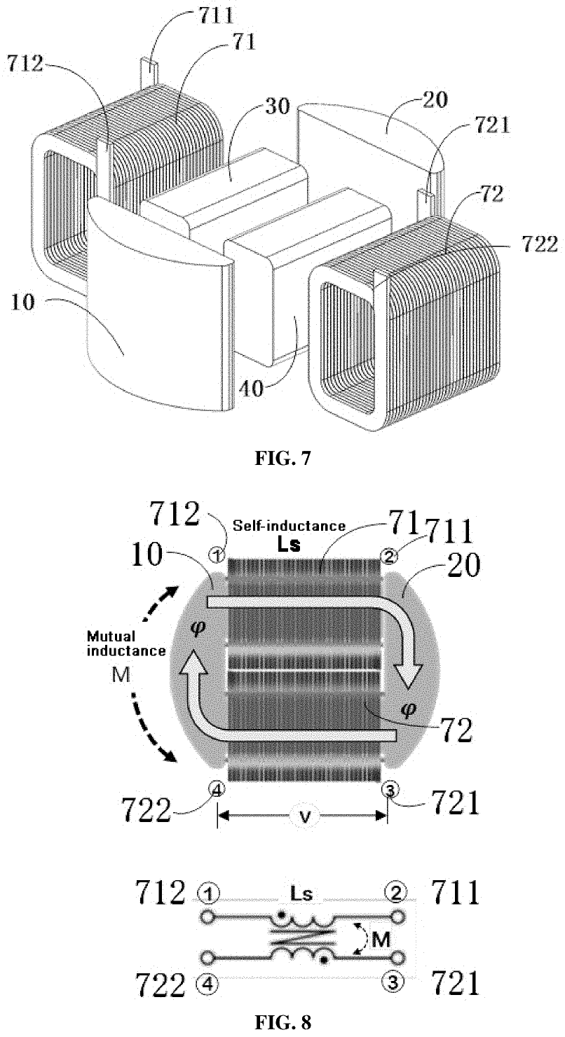

As shown in FIG. 6 and FIG. 7, they are a schematic diagram of a three-dimensional structure and a schematic diagram of a split structure of the inductor in one embodiment. The inductor includes a first magnetic core lobe 10, a second magnetic core lobe 20 and a conductive coil, wherein the conductive coil includes a first coil 71 and a second coil 72. The first coil 71 is wound around the first magnetic core column 30. The second coil 72 is wound around the second magnetic core column 40. The first coil 71 includes a first terminal 711 and a second terminal 712. The second coil 72 includes a third terminal 721 and a fourth terminal 722.

In one embodiment, the first coil 71 and the second coil 72 are rectangular flat copper wire vertical winding coils, and the direction in which the first coil 71 is wound around the first magnetic core column 30 is the same as the direction in which the second coil 72 is wound around the second magnetic core column 40.

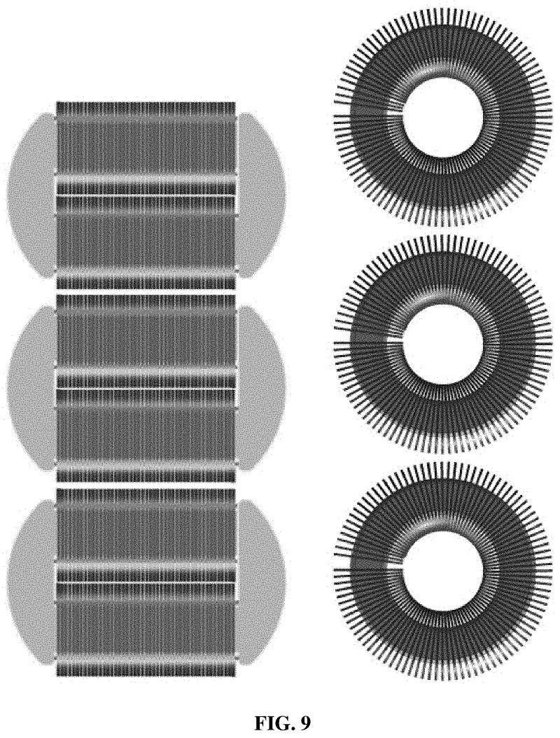

As shown in FIG. 8, it is a schematic diagram of the terminal connection of the inductor in one embodiment. The first terminal 712 of the first coil 71 serves as a terminal of the inductor, the second terminal 711 of the first coil 71 is connected to the third terminal 721 of the second coil 72, and the fourth terminal 722 of the second coil 72 serves as the other terminal of the inductor. For a single coil 71, its inductance is:

$$V = Ls \frac{{dI}_{1}}{dt} + M \frac{{dI}_{2}}{dt} ,$$

wherein, V represents the voltage across the both ends of the first coil 71, Ls represents the self-inductance of the first coil 71, M represents the mutual inductance formed by the magnetic coupling between the first coil 71 and the second coil 72, and I1 and I2 respectively represent the current flowing through the interiors of the two coils. φ represents the magnetic flux generated in a magnetic circuit by the current flowing in the two inductance coils.

When the first terminal 712 of the first coil 71 is connected to the third terminal 721 of the second coil 72, the two current values are the same, and the voltage across the both ends of a single coil can be expressed as follows:

$$V = ( Ls + M ) \frac{dI}{dt} ,$$

wherein, V represents the voltage across the both ends of the first coil 71, Ls represents the self-inductance of the first coil 71, M represents the mutual inductance formed by the magnetic coupling between the first coil 71 and the second coil 72, and I represents the current flowing through the interiors of the two coils.

It can be seen from the above description that, the inductance of a single coil (the first coil 71) is:

L=Ls+M

wherein, L represents the inductance, Ls represents the self-inductance of the first coil 71, and M represents the mutual inductance formed by the magnetic coupling between the first coil 71 and the second coil 72.

Then, the total inductance of the first coil 71 and the second coil 72 in series is:

L=2(Ls+M),

wherein, L represents the total inductance of the inductor, Ls represents the self-inductance of the first coil 71 or the second coil, and M represents the mutual inductance formed by the magnetic coupling between the first coil 71 and the second coil 72.

The inductance of the annular inductor with the annular magnetic core is:

L=(K*O*s*N²S)/I,

wherein, L represents the inductance of the annular inductor, K represents a coefficient, which depends on the ratio of the radius to the length of the coil, I represents the length of the coil, s represents the sectional area of the coil, N2 represents the square of the number of turns of the coil, S represents the relative permeability of the magnetic core in the coil, and O represents the vacuum permeability. Under the conditions of the same thickness of the conducting wire material of the conductive coil, the same number of winding turns, and the same size of the outer edge of the inductor, the inductance of the annular inductor is:

L=2Ls

wherein, Ls represents the self-inductance of the first coil 71 or the second coil 72, and the length of the coil of the annular inductor is the sum of the lengths of the first coil 71 and the second coil 72.

It can be seen from the above description that, under the conditions of the same thickness of the conducting wire material of the conductive coil, the same number of winding turns, and the same size of the outer edge of the inductor, the inductance of the inductor disclosed in the present application is greater than the inductance of the annular inductor.

In one embodiment, the first coil 71 and the second coil 72 of the inductor disclosed in the present application are not short-circuited to form a coupling inductor including two coils. Such an inductor is more suitable for occasions that, for example, an inverter outputs filter inductance in a single-phase AC manner, and each coil is used as a filter inductor on a phase line.

In one embodiment, for various interleaved parallel PFC circuits, interleaved parallel Boost circuits and other circuits requiring the interleaved working of two inductors, the coupling inductance of the inductor disclosed in the present application can be used as an interleaved parallel coupling form of two inductors. In use, one side of the inductor is short-circuited to serve as an interleaved parallel common input pole (for example, the 1 and 4 poles are connected to serve as common input), and the two outer 2 poles of the two coils are respectively connected to 2 interleaved parallel electrical circuits to form an implementation form of interleaved parallel dual-coupling inductance.

The winding directions of the two inductance coils of the inductor disclosed in the present application are completely the same to form the same magnetic flux flow direction, the two inductance coils can also be wound in opposite directions and in a diagonal short circuit manner to form magnetic flux in the same direction, and the effect is the same.

Further, in the inductor disclosed in the present application, flat vertical winding coils are neatly arranged at the middle, the arc surfaces of the magnetic core lobes on the both sides are located on the excircle contour of the annular inductor of the same size, therefore, the net sectional area of the magnetic core of the inductor disclosed in the present application is significantly increased, and the space occupancy of the coil is greatly increased, so that the space utilization rate of the coil and the magnetic core of the inductor disclosed in the present application is greatly improved, far exceeding the space utilization rate of the magnetic core material and winding coil of the annular vertical winding inductor. Specifically, under the conditions of the same thickness of the conducting wire material of the conductive coil, the same number of winding turns, and the same size of the outer edge of the inductor, the volume of the magnetic core wound by the first coil 71 and the second coil 72 of the inductor disclosed in the present application is greater than the volume of the magnetic core of the annular inductor. Therefore, the inductance of the inductor disclosed in the present application is also greater than the inductance of the annular inductor.

The inductor disclosed in the present application is different from a circular magnetic circuit formed by the annular magnetic core. In one embodiment, the magnetic circuit is a square magnetic circuit structure formed by combination of two crescent magnetic cores with both sides not wound and two rectangular winding magnetic cores, and the arc-surface-shaped outer side boundary of the crescent magnetic core constitutes the maximum boundary size of the inductor disclosed in the present application. Compared with the size of the annular vertical winding inductor, in terms of the outer diameter of the annular vertical winding inductor of the same size, in order to ensure that the sectional area of the magnetic core in the coil of the inductor disclosed in the present application is greater than the net sectional area of the circular ring-shaped magnetic core in the annular vertical winding inductor, after the flat copper wire vertical winding coils wound around the outside of the two upper and lower square magnetic core columns are assembled into the inductor of the present invention, the diagonal lengths of the two coils should not exceed 1.2 times the diameter length of an arc contour formed by the two crescent magnetic cores. In one embodiment, for the same sectional area of the copper wire of the conductive coil winding, the two upper and lower coils constituting the inductor disclosed in the present application are electrically connected in series, so as to obtain the inductance of the annular vertical winding inductor that is much greater than that under the same sectional area of the vertical winding wire. At the same time, under the above conditions, if the same magnetic core material is used, the inductance of the inductor disclosed in the present application in a current DC bias state is also greater than the DC bias inductance of the annular vertical winding inductor. Furthermore, if the adopted magnetic core material is different, since the effective area of the magnetic core of the inductor disclosed in the present application is increased, even if the magnetic material that has poor DC bias characteristics and is easy to saturate is used as the magnetic material in the novel inductor, the annular vertical winding inductor made of a material with good DC bias characteristics can also be replaced, and its electrical parameters can be maintained basically unchanged.

The inductor disclosed in the present application replaces the physical space of the annular vertical winding inductor of the same size, in order to achieve greater inductance. Based on the same principle, the present invention can obtain an implementation form of an inductor with the same inductance and greater power density by maintaining the same inductance ability as the annular vertical winding inductor of the same size, reducing the total number of turns of the coil and performing winding by use a conducting wire with a greater sectional area.

Further, although the inductor disclosed in the present application is an alternative to the physical space of the annular vertical winding inductor of the same size, the size of the inductor disclosed in the present application is as close as possible to a circle. In order to further improve the inductance of the inductor disclosed in the present application, the length of the magnetic core column inside the coil can be further elongated, so that the coil can get more winding space, thereby obtaining more turns per coil and greater inductance. At this time, the novel inductor that is approximately circular becomes a new implementation form that is approximately elliptical. In this implementation form, especially when multiple inductors are installed and arranged in parallel, as shown in FIG. 9, it is a schematic diagram of the spatial arrangement of an elliptical inductor and an annular inductor in one embodiment, and the inductor in the elliptical implementation form disclosed in the present application can further improve the space utilization rate of inductor installation.

The present application discloses an inductor, which includes the first magnetic core column and the second magnetic core column, which are the same, and the first magnetic core lobe and the same second magnetic core lobe, which are the same. Due to the optimized design of the structure of the magnetic core of the inductor, specifically through the optimized design of the shape of the magnetic core material and the winding structure, under the conditions of the same thickness of the conducting wires of the coils, the same number of winding turns, and the same outer size of the circular inductor as the annular vertical winding inductor, the net sectional area of the magnetic core material is significantly increased. Due to the significant increase in the net sectional area of the magnetic flux loop, for the inductor made of the same magnetic core material, its inductance is improved in proportion to the net sectional area of the magnetic core material, that is to say, in the same volume and shape of the original annular vertical winding inductor, even if the sectional area of the flat copper wire of the same size as the original annular vertical winding inductor is used, the inductance ability of the inductor disclosed in the present application is significantly improved by optimizing the shape and path of the magnetic circuit, and optimizing the shapes and sizes of the magnetic cores at different parts of the magnetic circuit of the inductor. Since the magnetic core of the inductor disclosed in the present application has a split structure, it is convenient for mass production of the inductor, thereby reducing the production cost.

Specific examples are used above to illustrate the present invention, are only used for helping understand the present invention, rather than limiting the present invention. For those skilled in the art to which the present invention belongs, according to the idea of the present invention, several simple deductions, modifications or substitutions can also be made.

Description is made herein with reference to various exemplary embodiments. However, those skilled in the art will recognize that changes and modifications can be made to the exemplary embodiments without departing from the scope of the text. For example, various operation steps and assemblies used for executing the operation steps can be implemented in different ways according to specific applications or by considering any number of cost functions associated with the operations of the system (for example, one or more steps can be deleted, modified or incorporated into other steps).

Although the principles of the test have been shown in various embodiments, many modifications of structures, arrangements, proportions, elements, materials and components that are particularly suitable for specific environments and operating requirements can be used without departing from the principles and scope of the this disclosure. The above modifications and other changes or amendments will be included in the scope of the text.

The foregoing detailed descriptions have been described with reference to various embodiments. However, those skilled in the art will recognize that various modifications and changes can be made without departing from the scope of the present disclosure. Therefore, the consideration of the present disclosure will be in an illustrative rather than restrictive sense, and all these modifications will be included in its scope. Likewise, the advantages, other advantages and solutions to problems of the various embodiments have been described above. However, benefits, advantages, solutions to problems, and any elements that can produce these, or solutions that make them more specific should not be construed as critical, essential or necessary. The term “including” and any other variants thereof used herein are non-exclusive inclusions. Such a process, method, article or equipment that includes a list of elements not only includes these elements, but also includes other elements that are not explicitly listed or do not belong to the process, method, system, article or equipment. In addition, the term “couple” and any other variants thereof used herein refer to physical connection, electrical connection, magnetic connection, optical connection, communication connection, functional connection and/or any other connection.

Those skilled in the art will recognize that many changes can be made to the details of the above-mentioned embodiments without departing from the basic principles of the present invention. Therefore, the scope of the present invention should be determined according to the following claims.

1. An inductor, comprising a first magnetic core column and a second magnetic core column, which are same, and a first magnetic core lobe and a second magnetic core lobe, which are same;
wherein each of the first magnetic core lobe and the second magnetic core lobe has two opposite side faces, and a bottom surface and an arc surface connect the two opposite side faces;
both of the first magnetic core column and the second magnetic core column are wound around by conductive coils; wherein one end of the conductive coil wound around the first magnetic core column serves as a terminal of the inductor, another end of the conductive coil wound around the first magnetic core column is connected to one end of the conductive coil wound around the second magnetic core column, and another end of the conductive coil wound around the second magnetic core column serves as another terminal of the inductor; and
the first magnetic core lobe and the second magnetic core lobe are arranged in such a manner that the bottom surfaces thereof are opposite to each other, and the first magnetic core column and the second magnetic core column are arranged side by side between the first magnetic core lobe and the second magnetic core lobe, so that end faces of the first magnetic core column and the second magnetic core column are in contact with the bottom surfaces of the first magnetic core lobe and the second magnetic core lobe respectively;
wherein at least one air gap is arranged in the first magnetic core lobe and the second magnetic core lobe; and/or, at least one air gap is arranged in the first magnetic core column and the second magnetic core column.

2. (canceled)

3. The inductor of claim 1, wherein outer edges of the first magnetic core column and/or the second magnetic core column are rounded;
wherein a radius of the round edge is one-tenth to one-fifth of a radius of circumcircle of the first magnetic core column or the second magnetic core column.

4. (canceled)

5. The inductor of claim 1, wherein edges between the bottom surfaces and the arc surfaces of the first magnetic core lobe and the second magnetic core lobe are rounded.

6. (canceled)

7. (canceled)

8. The inductor of claim 1, wherein a plane where the air gap in the first magnetic core lobe or the second magnetic core lobe is located is perpendicular to the bottom surface of the first magnetic core lobe or the second magnetic core lobe.

9. The inductor according to claim 1, wherein the air gap in the first magnetic core lobe or the second magnetic core lobe is arranged on a medial surface of the first magnetic core lobe or the second magnetic core lobe.

10. The inductor of claim 1, wherein position of the air gap in the first magnetic core lobe is different from position of the air gap in the second magnetic core lobe.

11. The inductor of claim 1, wherein number of the air gaps in the first magnetic core lobe is different from number of the air gaps in the second magnetic core lobe.

12. The inductor of claim 1, wherein the air gap in the first magnetic core column or the second magnetic core column is arranged on a medial surface of the first magnetic core column or the second magnetic core column.

13. The inductor of claim 1, wherein position of the air gap in the first magnetic core column is different from position of the air gap in the second magnetic core column.

14. The inductor of claim 1, wherein number of the air gaps of the first magnetic core column is different from number of the air gaps of the second magnetic core column.

15. The inductor of claim 1, wherein multiple parts of the first magnetic core lobe and the second magnetic core lobe divided by the air gaps are made of different materials.

16. The inductor according to claim 1, wherein multiple parts of the first magnetic core column and the second magnetic core column divided by the air gaps are made of different materials.

17. (canceled)

18. (canceled)

19. (canceled)

20. The inductor of claim 1, wherein the conductive coil is formed by flat wire wound vertically.

21. (canceled)

22. The inductor of claim 1, wherein on a transverse section of the inductor, a maximum distance on outer edge of the conductive coil is not greater than a maximum distance between the arc surfaces of the first magnetic core lobe and the second magnetic core lobe.

23. The inductor according to claim 1, wherein on a transverse section of the inductor, a maximum distance between the arc surfaces of the first magnetic core lobe and the second magnetic core lobe is 1.2 times a maximum distance on outer edge of the conductive coil.
